(19) United States
(12) Patent Application Publication
(10) Pub. No.: US 2010/0287719 A1
(43) Pub. Date: Nov. 18, 2010

(54) Two Sided Cleaning Device

(75) Inventor: Roberta Koehl, Calabasas, CA (US)

Correspondence Address: KLEINBERG & LERNER, LLP, 1875 CENTURY PARK EAST, SUITE 1150, LOS ANGELES, CA, 90067, US

(73) Assignee: Koehl Enterprises, Inc., Calabasas, CA (US)

(21) Appl. No.: 12/844,811

(22) Filed: Jul. 27, 2010

Related U.S. Application Data
(63) Continuation-in-part of application No. 12/427,557, filed on Apr. 21, 2009.

(51) Int. Cl. B43L 21/00

(52) U.S. Cl. 15/209.1

(57) ABSTRACT

A pad with two sides, one side being composed of a light or soft textile and the other side being composed of a heavier or coarser textile or a denser weave of the first textile. An additional embodiment incorporates a plastic layer between the two sides. The pad may be used for personal care, nail polish removal, cosmetics, and medical uses, among others.

### CROSS REFERENCE TO RELATED APPLICATIONS

The present application claims priority to, and is a continuation in part of, U.S. patent application Ser. No. 12/427,557, filed Apr. 21, 2009, the entirety of which is hereby incorporated by reference for all purposes.

### BACKGROUND

1. Field of the Invention

The present invention is in the field of textiles and cosmetic accessories.

2. Background of the Invention

Prior cotton pads were of one material. These pads were predominately used in the application or removal of cosmetics, although industrial uses were also possible. However, the use of a pad with only one material and weave was insufficient for many uses. For example, multiple pads were needed to address varying uses, such as applying cosmetics, removing excess cosmetics, medical uses or exfoliating skin. Simple cotton pads were frequently too weak and lacked durability for jobs that required more substantial pads. What is needed is a two sided pad composed of cotton and another textile, or of two different weaves of cotton.

### BRIEF SUMMARY OF THE INVENTION

The present invention is a two sided cotton pad. One side is of cotton. The other side is of another, more durable textile, or of a more durable weave of cotton. In another embodiment, a layer of plastic is inserted between the two sides to provide extra durability. This layer of plastic also serves to prevent liquids from penetrating to the other side of the pad. In an alternative embodiment the synthetic middle material can be processed with microscopic holes for extra durability. In the preferred embodiment, the invention is disposable after one or multiple uses. However, the extra durability imparted by the “coarse” or durable side allows the present invention to be used longer or for more repetitions than prior art pads. Non-disposable versions of the invention are also contemplated. In addition, the present invention provides for a pad that may be used for multiple tasks per usage of the pad. For example, a user could first use the soft side to remove light cosmetics and then use the coarse side to remove heavier cosmetics. In another example embodiment the coarse side could be used to clean a wound and the soft side could be used for absorption or on smooth surfaces. The present invention is an improvement over the prior art because it reduces the number of pads a user must use to accomplish certain tasks, because it reduces waste, and because it is more durable and cleans more efficiently than the pads of the prior art.

### BRIEF DESCRIPTION OF THE DRAWINGS

FIG. 1 illustrates the softer side of the present invention.

FIG. 2 illustrates the coarser side of the present invention.

FIG. 3 illustrates a cross section view of the preferred embodiment of the invention.

FIG. 4 illustrates a cross section view of one embodiment of the invention.

FIG. 5 illustrates a cross section view of one embodiment of the invention.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and changes may be made without departing from the scope of the present invention.

FIG. 1 illustrates a “soft” side 10 of one embodiment of the present invention. The “soft” side 10 is composed of cotton or a similar textile. The weave of the “soft” side 10 is composed of finer fibers than the other side. Other materials could be incorporated into the “soft” side 10 instead of cotton, including but not limited to, compressed or “lint free” cotton, latex, polyurethane, polyester, rayon, or other synthetic materials. Combinations of natural and synthetic fibers could also be incorporated to produce the “soft” side 10. In addition, the weave density or pattern may be varied to produce a “soft” side. In one embodiment, this side 10 may be constructed to be moderately durable so as to prevent cotton from detaching from the pad during use on the face and other areas. For example, compressed cotton could be utilized to take advantage of its well known low lint properties. The soft side 10 is also generally well adapted to absorption tasks. In some embodiments the “soft” side 10 is soft enough to use on delicate areas such as the face, similar to many cotton applicators or swabs of the prior art. The “soft” side 10 may be used for personal care, nail polish removal, cosmetics, and medical uses, among others.

FIG. 2 illustrates a “coarse” side 20 of one embodiment of the present invention. The “coarse” side 20 is composed of cotton or a similar textile. The “coarse” side 20 is generally coarser and thicker than the other side. In a preferred embodiment the side 20 is composed of a woven or non-woven cotton, more commonly known as gauze. Other compositions of side 20 are also contemplated. Other materials could be incorporated into the “coarse” side 20 instead of cotton, including but not limited to, compressed or “lint free” cotton, latex, polyurethane, polyester, and rayon. Combinations of natural and synthetic fibers could also be incorporated to produce the “coarse” side 20. In addition, the weave density or pattern of may be varied to produce a “coarse” side. The “coarse” side 20 provides structural integrity to the invention and increases its durability. This extra durability allows either side of the pad to be used multiple times, an improvement over the prior art. In addition, the “coarse” side 20 exhibits more absorption and requires less padding than prior art coarse pads due to the added cotton pad on the other side. The side 20 is adapted to handle tasks that require a strong pad, such as removing excess cosmetics or exfoliating skin. The “coarse” side 20 may be used for personal care, nail polish removal, cosmetics, cleaning wounds and other medical uses, among others.

The sides 10 and 20 may be attached to each other through adhesive. In the embodiment using adhesive the two sides are ideally woven to create relatively flat surfaces to adhere to each other. Similarly, sides 10 and 20 may be stitched together. In the embodiment where the sides are stitched together the sides are preferably generally flat to be stitched together. Additionally, the sides 10 and 20 may also be attached to each other through heat sealing. In the embodiment where the sides are attached through heat sealing the sides preferably are partially composed of synthetic fibers that will more easily melt and bond to each other. Additional methods of attachment, well known in the art, are contemplated. The two sides may also be attached via steel rule dye, radio frequency welding, ultrasonic welding, dye cutting, corded process, and hydro entanglement.

FIGS. 1 and 2 illustrate a circular pad design. However, these illustrations are for example only, and the invention is not so limited. The present invention could be composed of pads of nearly any size or shape. For example, two-sided pads of the current invention could be created in the shape of squares, rectangles, oblongs, hexagrams and ovals. Other shapes are also contemplated within the spirit of the invention. In addition, the present invention also contemplates three dimensional shapes, as will be discussed below.

FIG. 3 illustrates a cross sectional view of one embodiment of the invention. In this cross section a “soft” material 10 is layered onto a thin layer of plastic 30 which is then layered onto a “coarse” material 20. The addition of plastic layer 30 increases the durability of the pad, increasing the number of uses possible for each pad.

The sides 10 and 20 may be attached to plastic 30 through adhesive, heat sealing, stitching, ultrasonic welding, steel rule dye, radio frequency welding, dye cutting, corded process, and hydro entanglement.

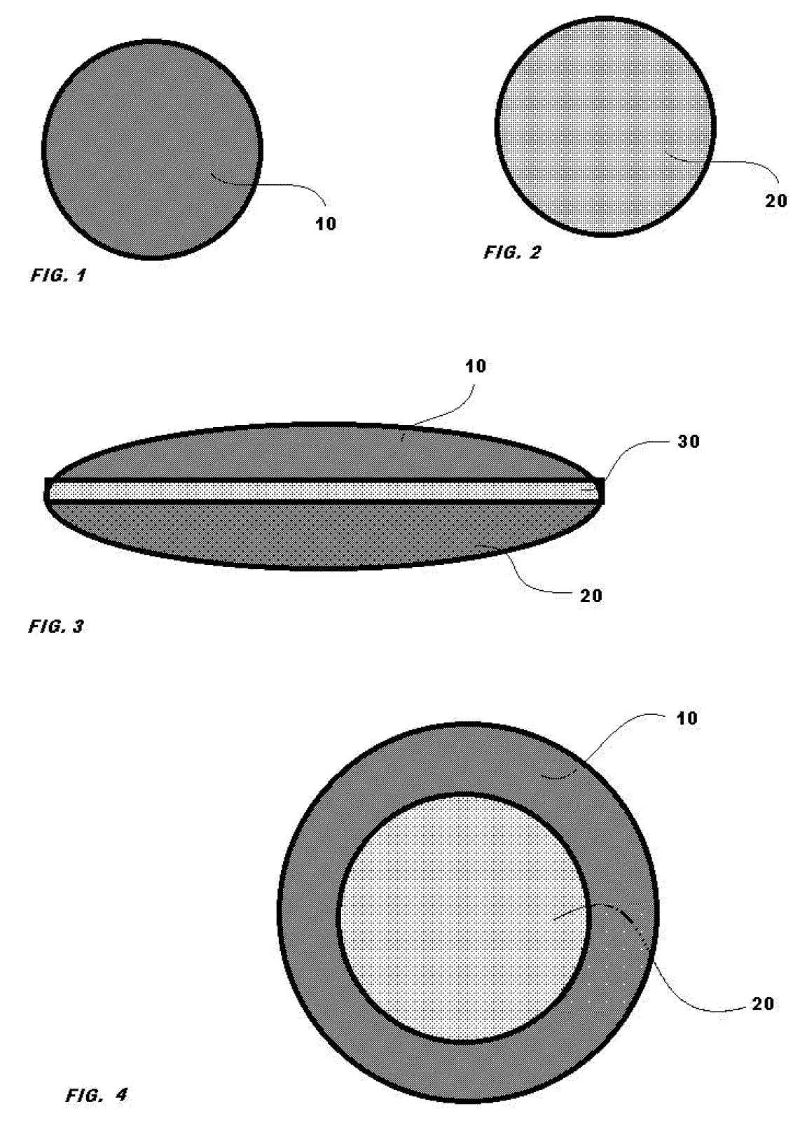

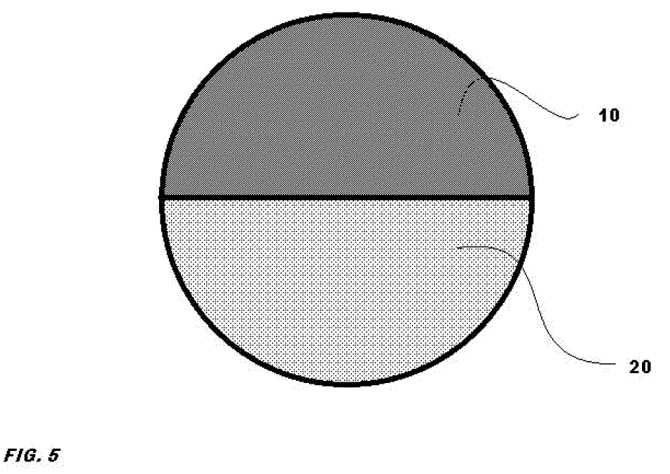

FIG. 4 illustrates a cross sectional view of one embodiment of the invention. In this embodiment of the invention the “soft” layer surrounds the “coarse” layer to make a three dimensional ball. The sphere of FIG. 4 is for example only; many other three dimensional shapes could be practiced without departing from the spirit of the invention. The coarser core of the spherical pad of FIG. 4 provides more stability and durability to the pad than would be provided by the “soft” material alone. In another embodiment the “soft” and “coarse” layers are reversed, so that the coarse surrounds the soft. This embodiment provides more softness and absorption than a pad of just a coarse material. The “soft” and “coarse” materials used in the embodiments of FIG. 4 can be any of the materials previously described.

FIG. 5 illustrates a cross sectional view of another embodiment of the invention. In this embodiment of the invention the “soft” layer has a depth and the “coarse” layer has a depth. Thus, in one embodiment illustrated in FIG. 5 the two lavers form a roughly spherical shape. The sphere of FIG. 5 is for example only; many other three dimensional shapes could be practiced without departing from the spirit of the invention. In this embodiment both sides are relatively thick and the thickness increases towards the middle of the pad. This increased thickness creates an advantage in durability and moisture absorption. The “soft” and “coarse” materials used in the embodiments of FIG. 5 can be any of the materials previously described.

What is claimed is:

1. A pad with a first side and a second side, said first side being composed of cotton and said second side being composed of gauze.

2. The pad of claim 1 wherein said first side is composed of lint-free cotton.

3. The pad of claim 1 wherein said first side is composed of a textile selected from the group consisting of cotton, compressed cotton, latex, polyurethane, polyester, and rayon.

4. The pad of claim 1, wherein said second side is composed of a textile selected from the group consisting of cotton, compressed cotton, latex, polyurethane, polyester, and rayon.

5. The pad of claim 1 wherein said first side is heat sealed to said second side.

6. The pad of claim 1 wherein said first side is stitched to said second side.

7. The pad of claim 1 wherein said first side is attached to said second side by adhesive.

8. The pad of claim 1 wherein a layer of plastic is present between said first side and said second side.

9. The pad of claim 8 wherein said layer of plastic is heat sealed to said first side and said second side.

10. The pad of claim 8 wherein said layer of plastic is stitched to said first side and said second side.

11. The pad of claim 8 wherein said layer of plastic is attached to said first side and said second side with adhesive.

12. A pad with an outer layer and an inner laver, said outer layer surrounding said inner layer, said outer layer being composed of gauze and said inner layer being composed of cotton.

13. The pad of claim 12 wherein said outer layer is composed of cotton and said inner layer is composed of gauze.

14. The pad of claim 12 wherein said outer layer is composed of a textile selected from the group consisting of cotton, compressed cotton, latex, polyurethane, polyester, and rayon.

15. The pad of claim 12 wherein said outer layer is composed of a textile selected from the group consisting of cotton, compressed cotton, latex, polyurethane, polyester, and rayon.
